(19) United States
(12) Patent Application Publication
(10) Pub. No.: US 2026/0019903 A1
(43) Pub. Date: Jan. 15, 2026

(54) COMMUNICATION METHOD, APPARATUS, AND DEVICE

(71) Applicant: SPREADTRUM SEMICONDUCTOR (NANJING) CO., LTD., Nanjing, Jiangsu (CN)

(72) Inventor: Chunyan CAO, Nanjing, Jiangsu (CN)

(73) Assignee: SPREADTRUM SEMICONDUCTOR (NANJING) CO., LTD., Nanjing, Jiangsu (CN)

(21) Appl. No.: 18/994,860

(22) PCT Filed: Jul. 13, 2023
(86) PCT No.: PCT/CN2023/107316

§ 371 Date: Jan. 15, 2025

(30) Foreign Application Priority Data
Jul. 15, 2022 (CN) 202210832207.X

(51) Int. Cl. H04W 36/08; H04W 76/14; H04W 76/20; H04W 92/18

(52) U.S. Cl. CPC H04W 36/08; H04W 76/14; H04W 76/20; H04W 92/18

(57) ABSTRACT

The present disclosure provides a communication method. The method includes: sending a handover request to a second network device, where the handover request is used to request a handover of a terminal device to a relay device, and the relay device is within a coverage of the second network device; receiving a handover response from the second network device, where the handover response includes a first local identifier, the first local identifier is used to identify the terminal device in relay communication after a handover to the relay device, and the first local identifier is different from a device identifier of the terminal device.

### CROSS-REFERENCE TO RELATED DISCLOSURE

This application is a National Stage of International Application No. PCT/CN2023/107316, filed on Jul. 13, 2023, which claims priority to Chinese Patent Application No. 202210832207.X, filed to China National Intellectual Property Administration on Jul. 15, 2022 and entitled “COMMUNICATION METHOD, APPARATUS, AND DEVICE”, both of which are incorporated by reference herein.

### TECHNICAL FIELD

The present disclosure relates to the field of communication technology and, in particular, to a communication method, an apparatus, and a device.

### BACKGROUND

In sidelink relay communication, a terminal device located at an edge of a cell can connect and communicate with a network device through a relay device.

In relay communication, it is likely to cause a security risk if a device identifier of a terminal device (for example, a source layer 2 identifier of the terminal device) is directly used to identify the terminal device. However, if the terminal device is not identified in the relay communication, service continuity of the terminal device cannot be guaranteed.

Therefore, research on how to ensure the service continuity of the terminal device while ensuring the communication security of the terminal device when a network handover (for example, switching to relay communication) occurs to the terminal device has important practical value for achieving secure relay communication.

### SUMMARY

The present disclosure provides a communication method, an apparatus, and a device.

In a first aspect, the present disclosure provides a communication method, applied to a first network device, the method including:
sending a handover request to a second network device, where the handover request is used to request a handover of a terminal device to a relay device, and the relay device is within a coverage of the second network device; and
receiving a handover response from the second network device, where the handover response includes a first local identifier, the first local identifier is used to identify the terminal device in relay communication after the handover to the relay device;
sending a radio resource control (RRC) reconfiguration message to the terminal device, where the RRC reconfiguration message includes the first local identifier.

In a second aspect, the present disclosure provides a communication method, applied to a terminal device, the method including:
receiving an RRC reconfiguration message from a first network device, where the RRC reconfiguration message includes a first local identifier, where the first local identifier is used to identify the terminal device in relay communication after a handover to a relay device, and the relay device is within a coverage of the second network device;
establishing a PC5 connection with the relay device, and sending an RRC reconfiguration complete message to the second network device via the relay device.

In a third aspect, the present disclosure provides a communication device, including: a processor, and a memory communicatively connected to the processor; where
the memory stores a computer program therein; and
the processor executes the computer program to cause the communication device to:
receive an RRC reconfiguration message from a first network device, where the RRC reconfiguration message includes a first local identifier, wherein the first local identifier is used to identify a terminal device in relay communication after a handover to a relay device, and the relay device is within a coverage of a second network device;
establish a PC5 connection with the relay device, and send an RRC reconfiguration complete message to the second network device via the relay device.

### BRIEF DESCRIPTION OF DRAWINGS

FIG. 1 is a schematic diagram of a sidelink relay communication architecture provided by an embodiment of the present disclosure.

FIG. 2 is a schematic diagram of a sidelink communication scenario in related art.

FIG. 3A is a schematic diagram of a communication system architecture provided in an embodiment of the present disclosure.

FIG. 3B is a schematic diagram of another communication system architecture provided in an embodiment of the present disclosure.

FIG. 4 is a schematic flowchart of a communication method provided in an embodiment of the present disclosure.

FIG. 5 is a schematic flowchart of another communication method provided in an embodiment of the present disclosure.

FIG. 6 is a schematic flowchart of yet another communication method provided in an embodiment of the present disclosure.

FIG. 7 is a schematic flowchart of yet another communication method provided in an embodiment of the present disclosure.

FIG. 8 is a schematic flowchart of yet another communication method provided in an embodiment of the present disclosure.

FIG. 9 is a schematic structure diagram of a communication apparatus provided in an embodiment of the present disclosure.

FIG. 10 is a schematic structure diagram of another communication apparatus provided in an embodiment of the present disclosure.

FIG. 11 is a schematic structure diagram of yet another communication apparatus provided in an embodiment of the present disclosure.

FIG. 12 is a schematic structure diagram of yet another communication apparatus provided in an embodiment of the present disclosure.

FIG. 13 is a schematic structure diagram of yet another communication apparatus provided in an embodiment of the present disclosure.

FIG. 14 is a schematic structure diagram of yet another communication apparatus provided in an embodiment of the present disclosure.

FIG. 15 is a schematic diagram of a hardware structure of a communication device provided in the present disclosure.

### DESCRIPTION OF EMBODIMENTS

Illustrative embodiments will be described herein in detail, and examples thereof are represented in accompanying drawings. When the following description relates to the accompanying drawings, the same numerals in the different accompanying drawings indicate the same or similar elements unless otherwise indicated. Implementations described in the following illustrative embodiments do not represent all embodiments consistent with the present disclosure, in contrast, they are only examples of apparatuses and methods consistent with some aspects of the present disclosure as detailed in appended claims.

It should be noted that the terms “including”, “comprising”, or any other variants thereof are intended to cover a non-exclusive inclusion herein, such that a process, method, article, or apparatus including a set of elements includes not only those elements but also other elements that are not expressly listed or that are inherent to such process, method, article or apparatus. Without further limitation, an element defined by the phrase “includes a . . . ” does not preclude the existence of other same elements in the process, method, article, or apparatus that includes this element.

The present disclosure relates to communication technology, and in order to facilitate the understanding of the embodiments of the present disclosure, related communication technologies involved are first described in detail.
1) PC5 interface: refers to a direct link communication interface between a terminal device and a terminal device. A communication link between the terminal device and the terminal device based on the PC5 interface can be called a sidelink (SL).
2) Uu interface: refers to a communication interface between a terminal device and a network device. A communication link between the terminal device and the network device can be called a direct link (Uu link)
3) Sidelink relay communication architecture:
as shown in FIG. 1, FIG. 1 is a schematic diagram of a sidelink relay communication architecture provided by an embodiment of the present disclosure. Referring to FIG. 1, the sidelink relay communication architecture includes a network device, a terminal device A, and a terminal device B.

The terminal device A is within a coverage of the network device and has a relay function. The communication quality between the terminal device B and the network device is poor, or, the terminal device B is outside the coverage of the network device. The terminal device B can realize communication with the network device through the relay function of the terminal device A.

In the above communication system architecture, a terminal device such as the terminal device A, which is within a coverage of a network device and can provide a relay service, can be referred to as a relay device (relay UE), and a terminal device such as the terminal device B, which accepts a relay service, can be referred to as a remote device (remote UE).

It should be understood that in the above sidelink relay communication architecture, one network device may cover multiple relay devices, and a relay device may provide relay services to one or more remote devices.

In the above communication system architecture, a network device can allocate a local identifier to a remote device to identify the remote device in relay communication, so that a relay device and a network device can identify the remote device. It should be noted that the local identifier is different from a device identifier of the remote device, and the local identifier identifies the remote device only in the relay communication.

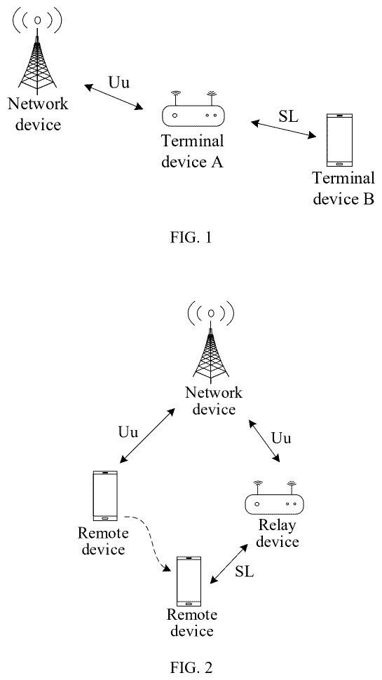

For ease of understanding, a scenario of allocating a local identifier in a sidelink communication system in related art is described below in conjunction with FIG. 2.

FIG. 2 is a schematic diagram of a sidelink communication scenario in related art. Referring to FIG. 2, a network device, a relay device, and a remote device are included.

When the communication quality between the remote device and the network device is good, the remote device can directly connect (communicate) with the network device. When the communication quality between the remote device and the network device is poor, the remote device can be handed over from the network device to a relay device within a coverage of the network device and communicate with the network device via the relay device. In that case, the network device can allocate a local identifier to the remote device to identify the remote device in relay communication.

However, when a location of the terminal device changes and a handover from the network device to a relay device within a coverage of another network device is required, the terminal device does not have a local identifier that can be recognized by another network device or the relay device within the coverage of another network device, so the terminal device is unable to carry out relay communication, and service continuity cannot be guaranteed.

In view of this, an embodiment of the present disclosure provides a communication method that can realize identifying a terminal device in relay communication by introducing a local identifier. For example, if a network device handover occurs to a terminal device, a local identifier is allocated to a remote device, which facilitates identifying of the terminal device in relay communication while ensuring the security of the relay communication in handover to a new network device, helping ensure the service continuity of the terminal device.

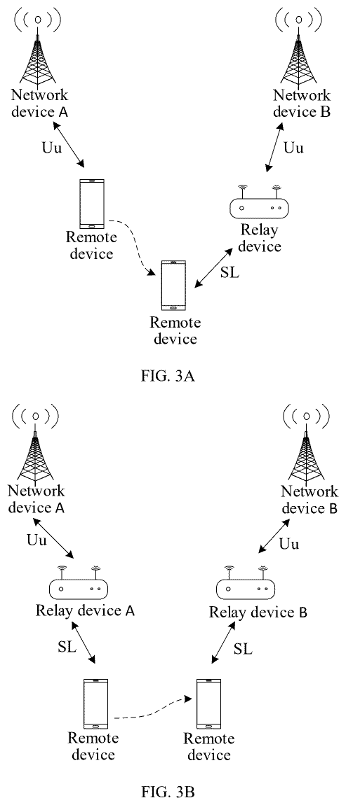

A communication system architecture involved in an embodiment of the present disclosure is described below in conjunction with FIG. 3A-FIG. 3B.

FIG. 3A is a schematic diagram of a communication system architecture provided in an embodiment of the present disclosure. As shown in FIG. 3A, a network device A, a network device B, a remote device, and a relay device are included. The relay device is within a coverage of the network device B.

The remote device can communicate directly with the network device A. When a location of the remote device changes, the remote device can be handed over from the network device A to the relay device. The network device B can allocate a local identifier to the remote device so that the remote device can communicate with the network device B via the relay device.

FIG. 3B is a schematic diagram of another communication system architecture provided in an embodiment of the present disclosure. As shown in FIG. 3B, a network device A, a relay device A, a network device B, a relay device B, and a remote device are included. The relay device A is within a coverage of the network device A. The relay device B is within a coverage of the network device B.

The remote device can communicate with the network device A via the relay device A. When a location of the remote device changes, the remote device can be handed over from the relay device A to the relay device B and can communicate with the network device B via the relay device B. When the remote device performs relay communication with the network device B, a local identifier used in the communication with the network device A can continue to be used; alternatively, the network device B can allocate a new local identifier to the remote device to enable the remote device to perform relay communication with the network device via the relay device B.

It should be noted that the system architecture described in embodiments of the present disclosure is intended to more clearly illustrate the technical solutions of the embodiments of the present disclosure, and does not constitute a limitation on the technical solutions provided by the embodiments of the present disclosure. A person of ordinary skill in the art can know that, with the evolution of the network architecture and the emergence of new service scenarios, the technical solutions provided by the embodiments of the present disclosure are equally applicable to similar problems.

The technical solutions of the present disclosure are described in detail below with specific embodiments. The following specific embodiments may be combined with each other, and the same or similar concepts or processes may not be repeated in some embodiments.

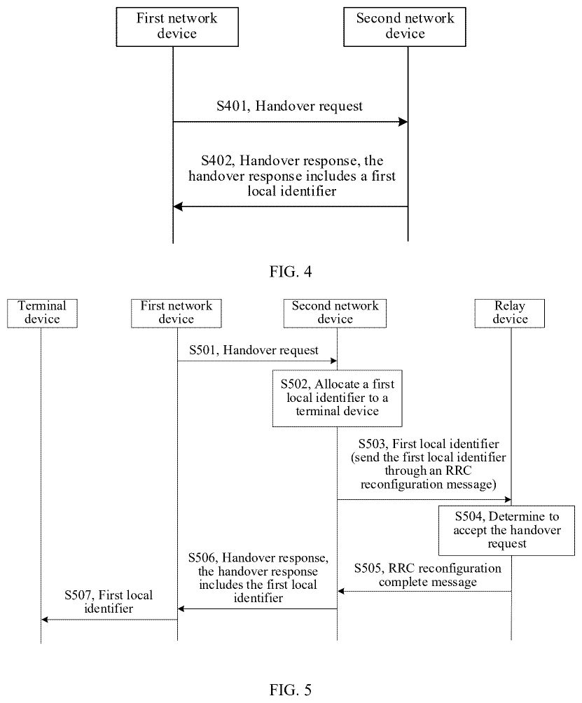

FIG. 4 is a schematic flowchart of a communication method provided in an embodiment of the present disclosure. As shown in FIG. 4, the method of the present embodiment includes:
S401, a first network device sends a handover request to a second network device.

The handover request is used to request a handover of a terminal device to a relay device, and the relay device is within a coverage of the second network device.

In a possible implementation, the handover request is further used to request an allocation of a local identifier for the terminal device.

In another possible implementation, the handover request includes a second local identifier to enable the second network device to allocate the local identifier to the terminal device based on the second local identifier.

The local identifier can be a specific identifier of the terminal device when the terminal device performs relay communication with a network device.

The second local identifier can be a specific identifier that identifies the terminal device in relay communication before the handover to the relay device, and the second local identifier is different from a device identifier of the terminal device.

The device identifier of the terminal device can be other identifiers that identify the terminal device in scenarios other than relay communication. For example, the device identifier of the terminal device can be a source layer 2 identifier (source L2 ID) of the terminal device or a factory identifier of the terminal device.

In the embodiment of the present disclosure, the handover request can also include a source layer 2 identifier of the terminal device, a source layer 2 identifier of the relay device, a cell identifier of the second network device, and configuration information of the terminal device in the first network device.

The terminal device can be an electronic device that can directly or indirectly communicate with a network device. For example, a terminal device may be a vehicle, a vehicle-mounted terminal, or a vehicle-mounted device, may also be a user terminal, a mobile device, or a remote device, or a roadside device.

The first network device can be a network device that provides a network service for the terminal device before the terminal device is handed over.

In a possible implementation, the first network device can communicate with the terminal device through a Uu link. That is, the first network device can directly provide a network service to the terminal device.

In another possible implementation, the first network device can communicate with a relay device within a coverage of the first network device through a Uu link, and the relay device within the coverage of the first network device can communicate with the terminal device through an SL link. That is, the first network device can indirectly provide a network service to the terminal device through the relay device.

The second network device can be a network device that provides a network service for the terminal device after the terminal device is handed over. The second network device can provide a network service for the terminal device through a relay function of a relay device.

Illustratively, in the embodiment of the present disclosure, both the first network device and the second network device may be an evolved base station (NodeB or eNB or e-NodeB, evolutional Node B) in a long term evolution (longterm evolution, LTE) system or an evolved LTE system (LTE-Advanced, LTE-A), or may also be a next generation node (next generation node B, gNB) in a fifth generation mobile communication technology (5th generation, 5G) new radio (NR) system, or may also be a network device in a public land mobile network (PLMN), etc.

S402, the second network device sends a handover response to the first network device, where the handover response includes a first local identifier.

The first local identifier is used to identify the terminal device in relay communication after the handover to the relay device, and the first local identifier is different from a device identifier of the terminal device.

The first local identifier may be a specific identifier of the terminal device when the terminal device is in relay communication with the second network device via the relay device. In the above relay communication, the second network device, or the relay device can recognize the terminal device by the first local identifier.

It should be understood that the first local identifier identifies the terminal device only in relay communication between the terminal device and the network device.

In the embodiment of the present disclosure, the handover response may also include a source layer 2 identifier of the relay device, a cell identifier of the second network device, and configuration information of the terminal device in the second network device, etc.

In the communication method provided by the present embodiment, the second network device can send the first local identifier to the first network device. The first local identifier is used to identify the terminal device in relay communication between the terminal device and the second network device. Through the above method, when a location of the terminal device changes, it can be handed over from the first network device to the relay device within the coverage of the second network device, and perform relay communication with the second network device, thereby ensuring the service continuity of the terminal device.

On the basis of the embodiment of FIG. 4, the second network device may further allocate a first local identifier to the terminal device. The second network device allocating the first local identifier to the terminal device can include at least the following two cases:

Case 1: the terminal device is not configured with a local identifier, and the second network device allocates a local identifier to the terminal device as the first local identifier.

Case 2: the terminal device is configured with a second local identifier, and the second network device uses the second local identifier as the first local identifier, or the second network device allocates a new local identifier to the terminal device as the first local identifier.

For the above case 1, acceptance of the handover request may be determined by the second network device, or acceptance of the handover request may be determined by the relay device.

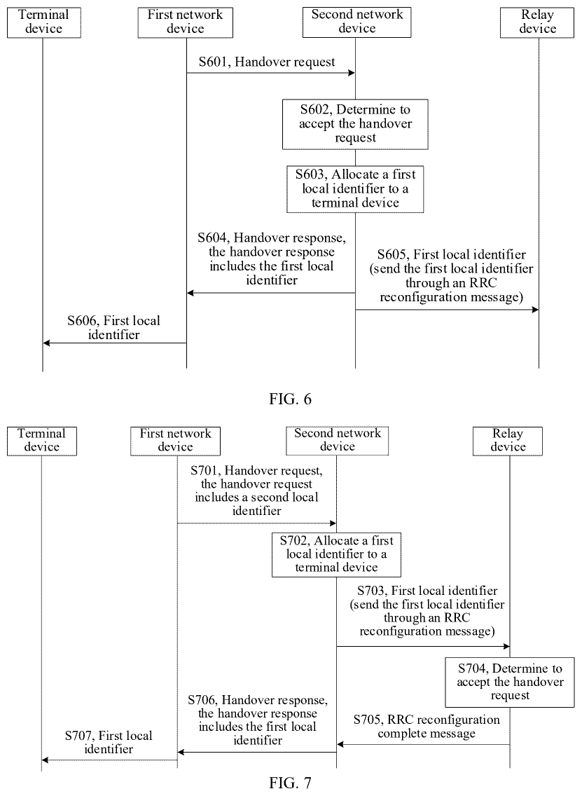

The above case 1 is described below in conjunction with FIG. 5 and FIG. 6.

FIG. 5 is a schematic flowchart of another communication method provided in an embodiment of the present disclosure. As shown in FIG. 5, the method of the present embodiment includes:

S501, a first network device sends a handover request to a second network device.

The handover request is used to request a handover of a terminal device to a relay device, where the relay device is within a coverage of the second network device; the handover request is further used to request an allocation of a local identifier for the terminal device.

The handover request may also include a source layer 2 identifier of the terminal device, a source layer 2 identifier of the relay device, a cell identifier of the second network device, and configuration information of the terminal device in the first network device, etc.

In the present embodiment, the first network device directly communicates with the terminal device communicate through a Uu link before the terminal device undergoes a handover.

S502, the second network device allocates a first local identifier to a terminal device.

Correspondingly, the second network device receives the handover request from the first network device.

The second network device can allocate the first local identifier to the terminal device based on the handover request and an available local identifier resource set of a cell where the second network device is located.

The available local identifier resource set may be a set of local identifiers that are not associated with other terminal devices.

In a possible implementation, the second network device shares a local identifier resource with the first network device. That is, the local identifier resource set of the cell where the second network device is located and the local identifier resource set of the cell where the first network device is located are a same local identifier resource set.

In another possible implementation, the second network device and the first network device are each configured with independent local identifier resources. That is, local identifier resources of the second network device are independent of local identifier resources of the first network device.

The second network device can randomly select a local identifier from the available local identifier resource set as the first local identifier. For example, the second network device can select a local identifier from the available local identifier resource set of the second network device as the first local identifier by using a random algorithm; or the second network device can also select a local identifier from the available local identifier resource set of the second network device as the first local identifier based on a selection rule. For example, the selection rule includes but is not limited to selecting sequentially, selecting in a reverse order, etc.

S503, the second network device sends the first local identifier to a relay device.

The second network device can send the first local identifier to the relay device in a form of a message. For example, the second network device can send a radio resource control (RRC) reconfiguration message to the relay device, where the RRC reconfiguration message includes the first local identifier.

The second network device can also send the relay device other information required when the relay device provides a relay service for the terminal device. For example, the second network device can also send the terminal device Uu link configuration information between the relay device and the second network device, SL link configuration information between the relay device and the terminal device, etc. In an implementation, the second network device can send the above information through an RRC reconfiguration message.

Before S503, this embodiment of the present disclosure may also include:
if the relay device is in an RRC idle state, or the relay device is in an RRC inactive state, the second network device can initiate a paging procedure for the relay device to trigger the relay device to execute an RRC connection establishment procedure, so as to enable the relay device to enter an RRC connected state. For the RRC connection establishment procedure, reference can be made to related art, which will not be described in detail herein.

S504, the relay device determines to accept the handover request.

Correspondingly, the relay device receives the first local identifier from the second network device.

In the present embodiment, the relay device can determine whether to accept the handover request.

The relay device can determine whether to accept the handover request of the terminal device at least based on parameters such as load of the relay device and service quality provided by the relay device.

Illustratively, if the load of the relay device does not exceed rated load and the relay device can provide good service quality, the relay device can accept the handover request of the terminal device; if the relay device is heavily loaded, or the service quality that the relay device can provide is poor, the relay device may not accept the handover request of the terminal device.

It should be noted that, in S504, the relay device can determine to accept the handover request or not to accept the handover request.

If the relay device accepts the handover request, the relay device can send an RRC reconfiguration complete message to the second network device (i.e., S505).

If the relay device does not accept the handover request, the relay device can send an RRC reconfiguration failure message to the second network device. In this case, the second network device can send the first network device a response message of rejecting the handover. After receiving the response message of rejecting the handover, the first network device can reselect a relay device and send a handover request to a network device corresponding to the reselected relay device (i.e., S501), which will not be described in detail herein.

S505, the relay device sends an RRC reconfiguration complete message to the second network device.

S506, the second network device sends a handover response to the first network device.

Correspondingly, the first network device receives the handover response from the second network device.

The handover response includes the first local identifier.

The handover response may also include a source layer 2 identifier of the relay device, a cell identifier of the second network device, and configuration information required for the terminal device to communicate with the second network device. For example, the handover response may also include configuration information between the relay device and the terminal device.

S507, the first network device sends the first local identifier to a terminal device.

The first network device can send the first local identifier to the terminal device in a form of a message. For example, the first network device can send an RRC reconfiguration message to the terminal device, where the RRC reconfiguration message includes the first local identifier.

The first network device can also send the terminal device other information required for the terminal device to perform relay communication with the second network device. For example, the first network device can also send configuration information of the terminal device in the second network device, the source layer 2 identifier of the relay device, and the cell identifier of the second network device to the terminal device, etc.

After S507, this embodiment of the present disclosure may also include:
after receiving the RRC reconfiguration message from the first network device, the terminal device can establish a PC5 connection with the relay device. The terminal device can also send an RRC reconfiguration complete message to the second network device via the relay device to indicate that the handover of the terminal device is completed.

The relay device can forward the RRC reconfiguration complete message of the terminal device to the second network device.

In the communication method provided in this embodiment, the second network device allocates the first local identifier to the terminal device based on the handover request, and can send the first local identifier to the first network device and the relay device. The relay device can determine to accept the handover request. Through the above method, when a location of the terminal device changes, it can be handed over from the first network device to the relay device within the coverage of the second network device, and perform relay communication with the second network device, thereby ensuring the service continuity of the terminal device.

FIG. 6 is a schematic flowchart of yet another communication method provided in an embodiment of the present disclosure. As shown in FIG. 6, the method of this embodiment includes:

S601, a first network device sends a handover request to a second network device.

The implementation of S601 can refer to the detailed description of S501, which will not be repeated here.

S602, the second network device determines to accept the handover request.

Correspondingly, the second network device receives the handover request from the first network device.

The second network device can determine whether to accept the handover request of the terminal device at least based on parameters such as load of a relay device, service quality provided by the relay device, and load of the second network device, etc.

Illustratively, if the load of the relay device and the load of the second network device do not exceed rated load, the relay device can provide good service quality, and then the second network device can accept the handover request of the terminal device; if the relay device has a high load, or the second network device has a high load, or the service quality that the relay device can provide is poor, then the second network device may not accept the handover request of the terminal device.

If the second network device accepts the handover request, then the second network device allocates a first local identifier to the terminal device (i.e., S603).

If the second network device does not accept the handover request, the second network device sends the first network device a response message of rejecting the handover. After receiving the response message of rejecting the handover, the first network device can reselect a relay device and send a handover request to a network device corresponding to the reselected relay device (i.e., S601), which will not be repeated here.

S603, the second network device allocates a first local identifier to a terminal device.

For the implementation method of S603, reference can be made to the detailed description of S502, which will not be repeated here.

S604, the second network device sends a handover response to the first network device.

S605, the second network device sends the first local identifier to a relay device.

For the implementation of S604, reference can be made to the detailed description of S506, and for the implementation of S605, reference can be made to the detailed description of S503, which will not be repeated here.

It should be noted that S604 and S605 can be executed simultaneously, or S604 can be executed before S605, or S604 can be executed after S605. There are no restrictions on the present disclosure.

S606, the first network device sends the first local identifier to the terminal device.

For the implementation method of S606, reference can be made to the detailed description of S507, which will not be repeated here.

In the communication method provided in this embodiment, the second network device can determine to accept the handover request, allocate the first local identifier to the terminal device based on the handover request, and send the first local identifier to the first network device and the relay device. Through the above method, when a location of the terminal device changes, it can be handed over from the first network device to the relay device within the coverage of the second network device, and perform relay communication with the second network device, thereby ensuring the service continuity of the terminal device.

For the above case 2, the acceptance of the handover request can by determined by the second network device, or the acceptance of the handover request can by determined by the relay device.

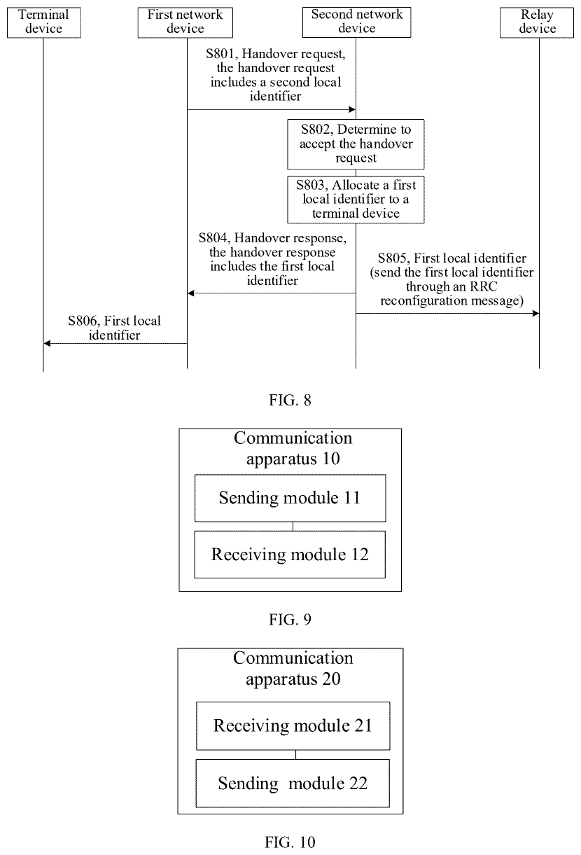

In conjunction with FIG. 7-FIG. 8, the above case 2 is described below.

FIG. 7 is a schematic flowchart of yet another communication method provided in an embodiment of the present disclosure. As shown in FIG. 7, the method of this embodiment includes:

S701, a first network device sends a handover request to a second network device, where the handover request includes a second local identifier.

The handover request is used to request a handover of a terminal device to a relay device, where the relay device is within a coverage of the second network device.

In this embodiment, before the terminal device is handed over, the first network device communicates with a relay device within a coverage of the first network device through a Uu link, and the relay device communicates with the terminal device through an SL link. That is, the terminal device indirectly communicates with the first network device via the relay device.

The second local identifier is used to identify the terminal device in communication before the handover to the relay device, and the second local identifier is different from a device identifier of the terminal device.

Furthermore, the second local identifier may be a local identifier of the terminal device when the terminal device performs relay communication with the first network device via the relay device within the coverage of the first network device.

The handover request may also include a source layer 2 identifier of the terminal device, a source layer 2 identifier of the relay device, a cell identifier of the second network device, configuration information of the terminal device in the first network device, etc.

S702, the second network device allocates a first local identifier to the terminal device.

Correspondingly, the second network device receives the handover request from the first network device.

The second network device can allocate the first local identifier to the terminal device based on the second local identifier in the handover request and an available local identifier resource set of a cell where the second network device is located.

The available local identifier resource set may be a set of local identifiers that are not associated with other terminal devices.

In a possible implementation, the second network device shares a local identifier resource with the first network device. That is, the local identifier resource set of the cell where the second network device is located and the local identifier resource set of the cell where the first network device is located are a same local identifier resource set.

In a possible implementation, the second local identifier is associated with a terminal device within the coverage of the second network device, and the second network device allocates the first local identifier to the terminal device.

Specifically, if the second local identifier is occupied by a terminal device within the coverage of the second network, the second network device can randomly select a local identifier from the available local identifier resource set as the first local identifier. For example, the second network device may select a local identifier from the available local identifier resource set of the second network device as the first local identifier by using a random algorithm; or the second network device may also select a local identifier from the available local identifier resource set of the second network device as the first local identifier based on a selection rule. For example, the selection rule includes but is not limited to selecting sequentially, selecting in a reverse order, etc.

Illustratively, assuming that the second local identifier is 5, and the local identifier of a certain terminal device within the coverage of the second network device used for relay communication is also 5, then the second local identifier is associated with the terminal device within the coverage of the second network device. The second network device allocates a first local identifier to the terminal device.

In another possible implementation, the second local identifier is not associated with a terminal device within the coverage of the second network device, and the second network device takes the second local identifier as the first local identifier.

Specifically, if the second local identifier is not occupied by a terminal device within the coverage of the second network, the terminal device may continue to use the second local identifier in relay communication with the second network device.

Illustratively, assuming that the second local identifier is 5, and the local identifier of any terminal device within the coverage of the second network device used for relay communication is not 5, then the second local identifier is not associated with the terminal device within the coverage of the second network device. The second network device can take the second local identifier as the first local identifier.

S703, the second network device sends the first local identifier to a relay device.

S704, the relay device determines to accept the handover request.

S705, the relay device sends an RRC reconfiguration complete message to the second network device.

S706, the second network device sends a handover response to the first network device.

S707, the first network device sends the first local identifier to the terminal device.

It should be understood that for the implementation of S703-S707, reference can be made to the detailed description of S503-S507, which will not be repeated here.

After S707, this embodiment of the present disclosure may also include:

After receiving the RRC reconfiguration message from the first network device, the terminal device can establish a PC5 connection with the relay device. The terminal device can also send an RRC reconfiguration complete message to the second network device via the relay device to indicate that the handover of the terminal device is completed.

The relay device can forward the RRC reconfiguration complete message of the terminal device to the second network device.

In the communication method provided in this embodiment, if the second local identifier is associated with a terminal device within the coverage of the second network device, the second network device can allocate the first local identifier to the terminal device; if the second local identifier is not associated with a terminal device within the coverage of the second network, the second network device can take the second local identifier as the first local identifier. The relay device can determine to accept the handover request. Through the above method, when a location of the terminal device changes, it can be handed over from the relay device within the coverage of the first network device to the relay device within the coverage of the second network device, and perform relay communication with the second network device, thereby ensuring the service continuity of the terminal device.

FIG. 8 is a schematic flowchart of yet another communication method provided in an embodiment of the present disclosure. As shown in FIG. 8, the method of this embodiment includes:

S801, a first network device sends a handover request to a second network device, where the handover request includes a second local identifier.

For the implementation of S801, reference can be made to the detailed description of S701, which will not be repeated here.

S802, the second network device determines to accept the handover request.

For the implementation method of S802, reference can be made to the detailed description of S602, which will not be repeated here.

S803, the second network device allocates a first local identifier to a terminal device.

For the implementation method of S803, reference can be made to the detailed description of S702, which will not be repeated here.

S804, the second network device sends a handover response to the first network device.

S805, the second network device sends the first local identifier to a relay device.

S806, the first network device sends the first local identifier to the terminal device.

For the implementation of S804-S806, reference can be made to the detailed description of S604-S606, which will not be repeated here.

After S806, this embodiment of the present disclosure may also include:
after receiving the RRC reconfiguration message from the first network device, the terminal device can establish a PC5 connection with the relay device. The terminal device can also send an RRC reconfiguration complete message to the second network device via the relay device to indicate that the handover of the terminal device is completed.

The relay device can forward the RRC reconfiguration complete message of the terminal device to the second network device.

In the communication method provided by this embodiment, the second network device can determine to accept the handover request. If the second local identifier is associated with a terminal device within the coverage of the second network device, the second network device can allocate the first local identifier to the terminal device; if the second local identifier is not associated with a terminal device within the coverage of the second network, the second network device can take the second local identifier as the first local identifier. Through the above method, when a location of the terminal device changes, it can be handed over from the first network device to the relay device within the coverage of the second network device, and perform relay communication with the second network device, thereby ensuring the service continuity of the terminal device.

FIG. 9 is a schematic structure diagram of a communication apparatus provided in an embodiment of the present disclosure. The communication apparatus provided in this embodiment may be a network device, or a module, a unit, a chip, a chip module, etc. in a network device. Please refer to FIG. 9, the communication apparatus 10 can be applied to a first network device, and include a sending module 11 and a receiving module 12, where,
the sending module 11 is configured to send a handover request to a second network device, where the handover request is used to request a handover of a terminal device to a relay device, and the relay device is within a coverage of the second network device; and
the receiving module 12 is configured to receive a handover response from the second network device, where the handover response includes a first local identifier, the first local identifier is used to identify the terminal device in relay communication after the handover to the relay device, and the first local identifier is different from a device identifier of the terminal device.

The communication apparatus provided in this embodiment can be configured to execute the communication method executed by the first network device in the above method embodiments, the implementation principle and the technical effect thereof are similar and will not be repeated here.

In a possible implementation, the handover request is further used to request an allocation of a local identifier for the terminal device.

In a possible implementation, the handover request includes a second local identifier, the second local identifier is used to identify the terminal device in communication before the handover to the relay device, and the second local identifier is different from the device identifier of the terminal device.

In a possible implementation, the second local identifier is the same as the first local identifier, where the second local identifier is not associated with a terminal device within the coverage of the second network device.

In a possible implementation, the sending module 11 is specifically configured to:
send the first local identifier to the terminal device.

In a possible implementation, the sending module 11 is specifically configured to:
send a radio resource control (RRC) reconfiguration message to the terminal device, where the RRC reconfiguration message includes the first local identifier.

The communication apparatus provided in this embodiment can be configured to execute the communication method executed by the first network device in the above method embodiments, and the implementation principle and the technical effect thereof are similar and will not be repeated here.

FIG. 10 is a schematic structure diagram of another communication apparatus provided in an embodiment of the present disclosure. The communication device provided in this embodiment may be a network device, or a module, a unit, a chip, a chip module, etc. in the network device. The communication apparatus provided in this embodiment may be a network device, or a module, a unit, a chip, a chip module, etc. in a network device. Please refer to FIG. 10, the communication apparatus 20 can be applied to a second network device, and include a receiving module 21 and a sending module 22, where,
the receiving module 21 is configured to receive a handover request from a first network device, where the handover request is used to request a handover of a terminal device to a relay device, and the relay device is within a coverage of the second network device; and
the sending module 22 is configured to send a handover response to the first network device, where the handover response includes a first local identifier, the first local identifier is used to identify the terminal device in relay communication after the handover to the relay device, and the first local identifier is different from a device identifier of the terminal device.

The communication apparatus provided in this embodiment can be configured to execute the communication method executed by the second network device in the above method embodiments, and the implementation principle and the technical effect thereof are similar and will not be repeated here.

In a possible implementation, the handover request is further used to request an allocation of a local identifier for the terminal device.

In a possible implementation, the handover request includes a second local identifier, the second local identifier is used to identify the terminal device in communication before the handover to the relay device, and the second local identifier is different from the device identifier of the terminal device.

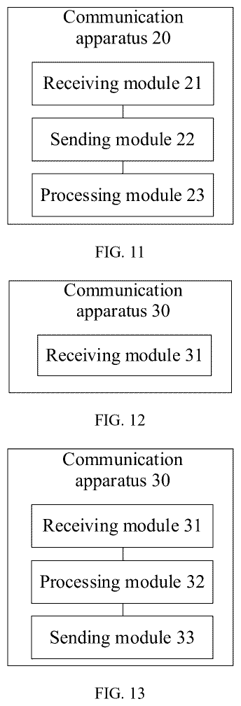

FIG. 11 is a schematic structure diagram of yet another communication apparatus provided in an embodiment of the present disclosure. On the basis of FIG. 10, referring to FIG. 11, the communication apparatus 20 further includes a processing module 23, where,
the processing module 23 is configured to determine that the second local identifier is associated with a terminal device within the coverage of the second network device.

In a possible implementation, the sending module 22 is specifically configured to:
if the second local identifier is not associated with a terminal device within the coverage of the second network device, send the handover response to the first network device, where the handover response includes the second local identifier.

In a possible implementation, the processing module 23 is specifically configured to:
determine to accept the handover request based on at least one of load of the relay device, service quality provided by the relay device, and load of the second network device.

In a possible implementation, the processing module 23 is specifically configured to:
if the relay device is in an RRC idle state, or in an RRC inactive state, initiate an RRC connection establishment procedure for the relay device, so as to enable the relay device to enter an RRC connected state.

In a possible implementation, the sending module 22 is specifically configured to:
send the first local identifier to the relay device.

In a possible implementation, the sending module 22 is specifically configured to:
send an RRC reconfiguration message to the relay device, where the RRC reconfiguration message includes the first local identifier.

The communication apparatus provided in this embodiment can be configured to execute the communication method executed by the second network device in the above method embodiments, and the implementation principle and the technical effect thereof are similar and will not be repeated here.

FIG. 12 is a schematic structure diagram of yet another communication apparatus provided in an embodiment of the present disclosure. The communication apparatus provided in this embodiment may be a relay device, or a module, a unit, a chip, a chip module, etc., in a relay device. Please refer to FIG. 12, the communication apparatus 30 can be applied to a relay device and include a receiving module 31, where,
the receiving module 31 is configured to receive a first local identifier from a second network device, where the relay device is within a coverage of the second network device, the first local identifier is used to identify a terminal device in relay communication after the terminal device is handed over to the relay device, and the first local identifier is different from a device identifier of the terminal device.

The communication apparatus provided in this embodiment can be configured to execute the communication method executed by the relay device in the above method embodiments, and the implementation principle and the technical effect thereof are similar and will not be repeated here.

In a possible implementation, the receiving module 31 is specifically configured to:
receive an RRC reconfiguration message from the second network device, where the RRC reconfiguration message includes the first local identifier.

In a possible implementation, the first local identifier is the same as a second local identifier, where the second local identifier is not associated with a terminal device within the coverage of the second network device, and the second local identifier is used to identify the terminal device in communication before the terminal device is handed over to the relay device.

FIG. 13 is a schematic structure diagram of yet another communication apparatus provided in an embodiment of the present disclosure. On the basis of FIG. 12, please refer to FIG. 13, the communication apparatus 30 further includes a processing module 32 and a sending module 33, where,
the processing module 32 is configured to determine to accept the handover of the terminal device to the relay device based on load of the relay device, and/or service quality that the relay device can provide; and
the sending module 33 is configured to send an RRC reconfiguration complete message to the second network device.

The communication apparatus provided in this embodiment can be configured to execute the communication method executed by the relay device in the above method embodiments, and the implementation principle and the technical effect thereof are similar and will not be repeated here.

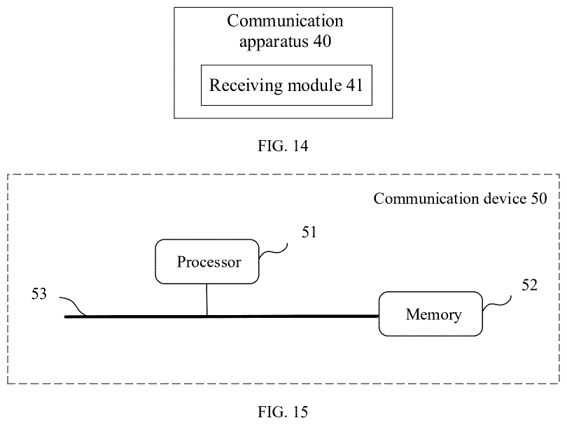

FIG. 14 is a schematic structure diagram of yet another communication apparatus provided in an embodiment of the present disclosure. The communication apparatus provided in this embodiment may be a terminal device, or a module, a unit, a chip, a chip module, etc., in a terminal device. Please refer to FIG. 14, the communication apparatus 40 can be applied to a terminal device and include a receiving module 41, where,
the receiving module 41 is configured to receive a first local identifier, where the first local identifier is used to identify the terminal device in relay communication after a handover to a relay device, the first local identifier is different from a device identifier of the terminal device, and the relay device is within a coverage of a second network device.

The communication apparatus provided in this embodiment can be configured to execute the communication method executed by the terminal device in the above method embodiments, and the implementation principle and the technical effect thereof are similar and will not be repeated here.

In a possible implementation, the receiving module 41 is specifically configured to:
receive an RRC reconfiguration message, where the RRC reconfiguration message includes the first local identifier.

In a possible implementation, the first local identifier is the same as a second local identifier, where the second local identifier is not associated with a terminal device within the coverage of the second network device, and the second local identifier is used to identify the terminal device in communication before the terminal device is handed over to the relay device.

The communication apparatus provided in this embodiment can be configured to execute the communication method executed by the terminal device in the above method embodiments, and the implementation principle and the technical effect thereof are similar and will not be repeated here.

FIG. 15 is a schematic diagram of a hardware structure of a communication device provided in the present disclosure. The communication device may be a network device, or a chip, a chip module, etc. in a network device. The communication device may also be a relay device, or a chip, a chip module, etc. in a relay device. The communication device may also be a terminal device, or a chip, a chip module, etc. in a terminal device. Please refer to FIG. 15, the communication device 50 may include: a processor 51 and a memory 52, where the processor 51 and the memory 52 can communicate. Illustratively, the processor 51 and the memory 52 communicate through a communication bus 53, the memory 52 is configured to store program instructions, and the processor 51 is configured to call the program instructions in the memory to execute the communication method shown in any of the above method embodiments.

In an implementation, the communication device 50 may further include a communication interface, where the communication interface may include a transmitter and/or a receiver.

In an implementation, the processor described above may be a central processing unit (CPU), or other general purpose processors, digital signal processors (DSPs), application specific integrated circuits (ASICs), etc. The general purpose processor may be a microprocessor, or the processor may be any conventional processor or the like. The content of the methods disclosed in the present disclosure can be directly embodied as being executed by a hardware processor, or executed by a combination of hardware and software modules in a processor.

An embodiment of the present disclosure further provides a computer-readable storage medium, where the computer-readable storage medium stores a computer program therein, and when the computer program is executed by a computer, the communication method as executed in any of the above method embodiments is implemented, and the implementation principles and the technical effects thereof are similar and will not be repeated here.

An embodiment of the present disclosure further provide a computer program product including a computer program, and when the computer program product is executed by a computer, the communication method executed by any of the above method embodiments is implemented, and the implementation principles and the technical effects thereof are similar and will not be repeated here.

All or part of the content to implement the method embodiments described above can be completed by a program instructing related hardware. The aforementioned program can be stored in a readable memory. When the program is executed, content including the method embodiments described above is performed. The aforementioned memory (storage medium) includes: a read-only memory (ROM), a RAM, a flash memory, a hard disk, a solid state disk, a magnetic tape, a floppy disk, an optical disc and any combination thereof.

The embodiments of the present disclosure are described with reference to a flowchart and/or a block diagram of a method, apparatus (system), and computer program product according to the embodiments of the present disclosure. It should be understood that each process and/or block in the flowchart and/or block diagram, as well as a combination of processes and/or blocks in the flowchart and/or block diagram, can be implemented by computer program instructions. These computer program instructions can be provided to a processing unit of a general purpose computer, a specialized computer, an embedded processing machine, or other programmable data processing devices to produce a machine so that the instructions executed through the processing unit of the computer or other programmable data processing device produce an apparatus for performing the functions specified in one or more processes in the flowchart and/or one or more blocks in the block diagrams.

These computer program instructions can also be stored in a computer-readable memory capable of directing a computer or other programmable data-processing device to work in a particular manner so that the instructions stored in the computer-readable memory result in a manufactured product including an instruction apparatus, where the instruction apparatus implements the functions specified in one or more processes in the flowchart and/or one or more blocks in the block diagrams.

These computer program instructions can also be loaded onto a computer or other programmable data processing device so that operational content is performed on the computer or other programmable device to produce computer-implemented processing, thereby the instructions executed on the computer or other programmable device provide content for implementing the functions specified in one or more processes in the flowchart and/or one or more blocks in the block diagrams.

Obviously, a person skilled in the art may make various changes and variants to the embodiments of the present disclosure without departing from the spirit and scope of the present disclosure. Thus, if these modifications and variants of the embodiments of the present disclosure fall within the scope of the claims of the present disclosure and equivalents thereof, the present disclosure is also intended to include such modifications and variants.

In the present disclosure, the term “include” and variations thereof may refer to a non-limiting inclusion; the term “or” and variations thereof may refer to “and/or”. In the present disclosure, the terms “first”, “second”, etc. are used to distinguish similar objects and are not necessarily used to describe a specific sequence or an order. In the present disclosure, “multiple” means two or more. “And/or” describes an association relationship of associated objects, and indicates that three relationships can exist. For example, A and/or B can mean that: A exists alone, A and B exist at the same time, and B exists alone. The character “/” generally indicates that previous and next associated objects are in an “or” relationship.

The present disclosure provides a communication method, an apparatus, and a device.

In a first aspect, the present disclosure provides a communication method, applied to a first network device, the method including:
sending a handover request to a second network device, where the handover request is used to request a handover of a terminal device to a relay device, and the relay device is within a coverage of the second network device; and
receiving a handover response from the second network device, where the handover response includes a first local identifier, the first local identifier is used to identify the terminal device in relay communication after the handover to the relay device, and the first local identifier is different from a device identifier of the terminal device.

In a possible implementation, the handover request is further used to request an allocation of a local identifier for the terminal device.

In a possible implementation, the handover request includes a second local identifier, the second local identifier is used to identify the terminal device in communication before the handover to the relay device, and the second local identifier is different from the device identifier of the terminal device.

In a possible implementation, the second local identifier is the same as the first local identifier, where the second local identifier is not associated with a terminal device within the coverage of the second network device.

In a possible implementation, the method further includes:
sending the first local identifier to the terminal device.

In a possible implementation, the sending the first local identifier to the terminal device includes:
sending a radio resource control (RRC) reconfiguration message to the terminal device, where the RRC reconfiguration message includes the first local identifier.

In a second aspect, the present disclosure provides a communication method, applied to a second network device, the method including:
receiving a handover request from a first network device, where the handover request is used to request a handover of a terminal device to a relay device, and the relay device is within a coverage of the second network device; and
sending a handover response to the first network device, where the handover response includes a first local identifier, the first local identifier is used to identify the terminal device in relay communication after the handover to the relay device, and the first local identifier is different from a device identifier of the terminal device.

In a possible implementation, the handover request is further used to request an allocation of a local identifier for the terminal device.

In a possible implementation, the handover request includes a second local identifier, the second local identifier is used to identify the terminal device in communication before the handover to the relay device, and the second local identifier is different from the device identifier of the terminal device.

In a possible implementation, the method further includes:
determining that the second local identifier is associated with a terminal device within the coverage of the second network device.

In a possible implementation, the method further includes:
if the second local identifier is not associated with a terminal device within the coverage of the second network device, sending the handover response to the first network device, where the handover response includes the second local identifier.

In a possible implementation, the method further includes:
determining to accept the handover request based on at least one of load of the relay device, service quality provided by the relay device, and load of the second network device.

In a possible implementation, the method further includes:
if the relay device is in an RRC idle state, or in an RRC inactive state, initiating an RRC connection establishment procedure for the relay device, so as to enable the relay device to enter an RRC connected state.

In a possible implementation, the method further includes:
sending the first local identifier to the relay device.

In a possible implementation, the sending the first local identifier to the relay device includes:
sending an RRC reconfiguration message to the relay device, where the RRC reconfiguration message includes the first local identifier.

In a third aspect, the present disclosure provides a communication method, applied to a relay device, the method including:
receiving a first local identifier from a second network device, where the relay device is within a coverage of the second network device, the first local identifier is used to identify a terminal device in relay communication after the terminal device is handed over to the relay device, and the first local identifier is different from a device identifier of the terminal device.

In a possible implementation, the receiving the first local identifier from the second network device includes:
receiving an RRC reconfiguration message from the second network device, where the RRC reconfiguration message includes the first local identifier.

In a possible implementation, the first local identifier is the same as a second local identifier, where the second local identifier is not associated with a terminal device within the coverage of the second network device, and the second local identifier is used to identify the terminal device in communication before the terminal device is handed over to the relay device.

In a possible implementation, the method further includes:
determining to accept the handover of the terminal device to the relay device based on load of the relay device, and/or service quality that the relay device can provide.

In a possible implementation, the method further includes:
sending an RRC reconfiguration complete message to the second network device.

In a fourth aspect, the present disclosure provides a communication method, applied to a terminal device, the method including:
receiving a first local identifier, where the first local identifier is used to identify the terminal device in relay communication after a handover to a relay device, the first local identifier is different from a device identifier of the terminal device, and the relay device is within a coverage of a second network device.

In a possible implementation, the receiving the first local identifier includes:
receiving an RRC reconfiguration message, where the RRC reconfiguration message includes the first local identifier.

In a possible implementation, the first local identifier is the same as a second local identifier, where the second local identifier is not associated with a terminal device within the coverage of the second network device, and the second local identifier is used to identify the terminal device in communication before the terminal device is handed over to the relay device.

In a fifth aspect, the present disclosure provides a communication apparatus, applied to a first network device, including: a sending module and a receiving module; where
the sending module is configured to send a handover request to a second network device, where the handover request is used to request a handover of a terminal device to a relay device, and the relay device is within a coverage of the second network device; and
the receiving module is configured to receive a handover response from the second network device, where the handover response includes a first local identifier, the first local identifier is used to identify the terminal device in relay communication after the handover to the relay device, and the first local identifier is different from a device identifier of the terminal device.

In a possible implementation, the handover request is further used to request an allocation of a local identifier for the terminal device.

In a possible implementation, the handover request includes a second local identifier, the second local identifier is used to identify the terminal device in communication before the handover to the relay device, and the second local identifier is different from the device identifier of the terminal device.

In a possible implementation, the second local identifier is the same as the first local identifier, where the second local identifier is not associated with a terminal device within the coverage of the second network device.

In a possible implementation, the sending module is specifically configured to:
send the first local identifier to the terminal device.

In a possible implementation, the sending module is specifically configured to:
send a radio resource control (RRC) reconfiguration message to the terminal device, where the RRC reconfiguration message includes the first local identifier.

In a sixth aspect, the present disclosure provides a communication apparatus, applied to a second network device, including: a receiving module and a sending module; where
the receiving module is configured to receive a handover request from a first network device, where the handover request is used to request a handover of a terminal device to a relay device, and the relay device is within a coverage of the second network device; and
the sending module is configured to send a handover response to the first network device, where the handover response includes a first local identifier, the first local identifier is used to identify the terminal device in relay communication after the handover to the relay device, and the first local identifier is different from a device identifier of the terminal device.

In a possible implementation, the handover request is further used to request an allocation of a local identifier for the terminal device.

In a possible implementation, the handover request includes a second local identifier, the second local identifier is used to identify the terminal device in communication before the handover to the relay device, and the second local identifier is different from the device identifier of the terminal device.

In a possible implementation, the communication apparatus further includes a processing module, where
the processing module is configured to determine that the second local identifier is associated with a terminal device within the coverage of the second network device.

In a possible implementation, the sending module is specifically configured to:
if the second local identifier is not associated with a terminal device within the coverage of the second network device, send the handover response to the first network device, where the handover response includes the second local identifier.

In a possible implementation, the processing module is specifically configured to:
determine to accept the handover request based on at least one of load of the relay device, service quality provided by the relay device, and load of the second network device.

In a possible implementation, the processing module is specifically configured to:
if the relay device is in an RRC idle state, or in an RRC inactive state, initiate an RRC connection establishment procedure for the relay device, so as to enable the relay device to enter an RRC connected state.

In a possible implementation, the sending module is specifically configured to:
send the first local identifier to the relay device.

In a possible implementation, the sending module is specifically configured to:
send an RRC reconfiguration message to the relay device, where the RRC reconfiguration message includes the first local identifier.

In a seventh aspect, the present disclosure provides a communication apparatus, applied to a relay device, including: a receiving module; where
the receiving module is configured to receive a first local identifier from a second network device, where the relay device is within a coverage of the second network device, the first local identifier is used to identify a terminal device in relay communication after the terminal device is handed over to the relay device, and the first local identifier is different from a device identifier of the terminal device.

In a possible implementation, the receiving module is specifically configured to:
receive an RRC reconfiguration message from the second network device, where the RRC reconfiguration message includes the first local identifier.

In a possible implementation, the first local identifier is the same as a second local identifier, where the second local identifier is not associated with a terminal device within the coverage of the second network device, and the second local identifier is used to identify the terminal device in communication before the terminal device is handed over to the relay device.

In a possible implementation, the communication apparatus further include a processing module and a sending module, where
the processing module is configured to determine to accept the handover of the terminal device to the relay device based on load of the relay terminal device, and/or service quality that the relay terminal device can provide; and
the sending module is configured to send an RRC reconfiguration complete message to the second network device.

In an eighth aspect, the present disclosure provides a communication apparatus, applied to a terminal device, including: a receiving module; where
the receiving module is configured to receive a first local identifier, where the first local identifier is used to identify the terminal device in relay communication after a handover to a relay device, the first local identifier is different from a device identifier of the terminal device, and the relay device is within a coverage of a second network device.

In a possible implementation, the receiving module is specifically configured to:
receive an RRC reconfiguration message, where the RRC reconfiguration message includes the first local identifier.

In a possible implementation, the first local identifier is the same as a second local identifier, where the second local identifier is not associated with a terminal device within the coverage of the second network device, and the second local identifier is used to identify the terminal device in communication before the terminal device is handed over to the relay device.

In a ninth aspect, the present disclosure provides a communication device, including: a processor, and a memory communicatively connected to the processor; where
the memory stores a computer program therein; and
the processor executes the computer program to implement the method according to any one of the first aspect.

In a tenth aspect, the present disclosure provides a communication device, including: a processor, and a memory communicatively connected to the processor; where
the memory stores a computer program therein; and
the processor executes the computer program to implement the method according to any one of the second aspect.

In an eleventh aspect, the present disclosure provides a communication device, including: a processor, and a memory communicatively connected to the processor; where
the memory stores a computer program therein; and
the processor executes the computer program to implement the method according to any one of the third aspect.

In a twelfth aspect, the present disclosure provides a communication device, including: a processor, and a memory communicatively connected to the processor; where
the memory stores a computer program therein; and
the processor executes the computer program to implement the method according to any one of the fourth aspect.

In a thirteenth aspect, the present disclosure provides a non-transitory computer-readable storage medium, where the computer-readable storage medium stores a computer program therein, and when the computer program is executed by a computer, the method as described in any one of the first aspect is implemented.

In a fourteenth aspect, the present disclosure provides a non-transitory computer-readable storage medium, where the computer-readable storage medium stores a computer program therein, and when the computer program is executed by a computer, the method as described in any one of the second aspect is implemented.

In a fifteenth aspect, the present disclosure provides a non-transitory computer-readable storage medium, where the computer-readable storage medium stores a computer program therein, and when the computer program is executed by a computer, the method as described in any one of the third aspect is implemented.

In a sixteenth aspect, the present disclosure provides a non-transitory computer-readable storage medium, where the computer-readable storage medium stores a computer program therein, and when the computer program is executed by a computer, the method as described in any one of the fourth aspect is implemented.

In a seventeenth aspect, the present disclosure provides a computer program product, including a computer program, and when the computer program is executed by a computer, the method as described in any one of the first aspect is implemented.

In a eighteenth aspect, the present disclosure provides a computer program product, including a computer program, and when the computer program is executed by a computer, the method as described in any one of the second aspect is implemented.

In a nineteenth aspect, the present disclosure provides a computer program product, including a computer program, and when the computer program is executed by a computer, the method as described in any one of the third aspect is implemented.

In a twentieth aspect, the present disclosure provides a computer program product, including a computer program, and when the computer program is executed by a computer, the method as described in any one of the fourth aspect is implemented.

In a twenty-first aspect, the present disclosure provides a chip, where the chip stores a computer program therein, and when the computer program is executed by the chip, the method as described in any one of the first aspects is implemented. The chip may also be a chip module.

In a twenty-second aspect, the present disclosure provides a chip, where the chip stores a computer program therein, and when the computer program is executed by the chip, the method as described in any one of the second aspects is implemented. The chip may also be a chip module.

In a twenty-third aspect, the present disclosure provides a chip, where the chip stores a computer program therein, and when the computer program is executed by the chip, the method as described in any one of the third aspects is implemented. The chip may also be a chip module.

In a twenty-fourth aspect, the present disclosure provides a chip, where the chip stores a computer program therein, and when the computer program is executed by the chip, the method as described in any one of the fourth aspects is implemented. The chip may also be a chip module.

The present disclosure provides a communication method, an apparatus and a device, where a network device allocates a local identifier to a terminal device which is newly handed over to a coverage of the network device through a handover procedure, which enables the terminal device to perform relay communication after handover, thereby ensuring the service continuity of the terminal device.

1. A communication method, applied to a first network device, the method comprising:
sending a handover request to a second network device, wherein the handover request is used to request a handover of a terminal device to a relay device, and the relay device is within a coverage of the second network device;
receiving a handover response from the second network device, wherein the handover response comprises a first local identifier, the first local identifier is used to identify the terminal device in relay communication after the handover to the relay device;
sending a radio resource control (RRC) reconfiguration message to the terminal device, wherein the RRC reconfiguration message comprises the first local identifier.

2. The method according to claim 1, wherein the handover request is further used to request an allocation of a local identifier for the terminal device.

3. The method according to claim 1, wherein the handover request comprises a second local identifier, the second local identifier is used to identify the terminal device in communication before the handover to the relay device, and the second local identifier is different from the device identifier of the terminal device.

4. The method according to claim 3, wherein the second local identifier is the same as the first local identifier, wherein the second local identifier is not associated with a terminal device within the coverage of the second network device.

5-19. (canceled)

20. A communication method, applied to a terminal device, the method comprising:
receiving a radio resource control (RRC) reconfiguration message from a first network device, wherein the RRC reconfiguration message comprises a first local identifier, wherein the first local identifier is used to identify the terminal device in relay communication after a handover to a relay device, and the relay device is within a coverage of a second network device;
establishing a PC5 connection with the relay device, and sending an RRC reconfiguration complete message to the second network device via the relay device.

21. (canceled)

22. The method according to claim 20, wherein the first local identifier is the same as a second local identifier, wherein the second local identifier is not associated with a terminal device within the coverage of the second network device, and the second local identifier is used to identify the terminal device in communication before the terminal device is handed over to the relay device.

23-26. (canceled)

27. A communication device, comprising: a processor, and a memory communicatively connected to the processor; wherein,
the memory stores a computer program therein; and
the processor executes the computer program to cause the communication device to:
receive a radio resource control (RRC) reconfiguration message from a first network device, wherein the RRC reconfiguration message comprises a first local identifier, wherein the first local identifier is used to identify a terminal device in relay communication after a handover to a relay device, and the relay device is within a coverage of a second network device;
establish a PC5 connection with the relay device, and send an RRC reconfiguration complete message to the second network device via the relay device.

28-29. (canceled)

30. The device according to claim 27, wherein the first local identifier is the same as a second local identifier, wherein the second local identifier is not associated with a terminal device within the coverage of the second network device, and the second local identifier is used to identify the terminal device in communication before the terminal device is handed over to the relay device.
